(19) United States
(12) Patent Application Publication
(10) Pub. No.: US 2006/0015373 A1
(43) Pub. Date: Jan. 19, 2006

(54) System and method for automated establishment of experience ratings and/or risk reserves

(75) Inventor: Frank Cuypers, Zurich (CH)

Correspondence Address: OLIFF & BERRIDGE, PLC, P.O. BOX 19928, ALEXANDRIA, VA, 22320, US

(73) Assignee: Swiss Reinsurance Company, Zurich (CH)

(21) Appl. No.: 10/531,459

(22) PCT Filed: Sep. 10, 2003
(86) PCT No.: PCT/CH03/00612

§ 371 Date: Apr. 14, 2005

(51) Int. Cl. G06Q 40/00; G06F 15/18

(52) U.S. Cl. 705/4; 706/16

(57) ABSTRACT

System and method for automated experience rating and/or loss reserving for events, a certain event P_{i,f} of an initial year i including development values P_{ikf} with development year k. For i, k applicable is i=1, . . . , K and k=1, . . . , K, K being the last known development year, and the first initial year i=1 comprising all development values P_{1kf} in a specified way. To determine the development values P_{i,K-(i-j)+1,f} neural networks N_{i,j} are generated iteratively for each initial year i (i−1), whereby j=1, . . . ,(i−1) are the number of iterations for a particular initial year i and whereby the neural network N_{i,j+1} depends recursively on the neural network N_{i,j}. In particular the system and method is suitable for experience rating for insurance contracts and/or excess of loss reinsurance contracts.

The invention relates to a system and a method for automated experience rating and/or loss reserving, a certain event P_{if} of an initial time interval i with f=1, . . . ,Fᵢ for a sequence of development intervals k=1, . . . ,K including development values P_{ikf}. For the events P_{1f} of the first initial time interval i=1, all development values P_{1kf}f=1, . . . ,F₁ are known. The invention relates particularly to a computer program product for carrying out this method.

Experience rating relates in the prior art to value developments of parameters of events which take place for the first time in a certain year, the incidence year or initial year, and the consequences of which propagate over several years, the so-called development years. Expressed more generally, the events take place at a certain point in time, and develop at given time intervals. Furthermore, the event values of the same event demonstrate over the different development years or development time intervals a dependent, retrospective development. The experience rating of the values takes place through extrapolation and/or comparison with the value development of known similar events in the past.

A typical example in the prior art is the several years' experience rating based upon damage events, e.g., of the payment status Z or the reserve status R of a damage event at insurance companies or reinsurers. In the experience rating of damage events, an insurance company knows the development of every single damage event from the time of the advice of damage up to the current status or until adjustment. In the case of experience rating, the establishment of the classic credibility formula through a stochastic model dates from about 30 years ago; since then, numerous variants of the model have been developed, so that today an actual credibility theory may be spoken of. The chief problem in the application of credibility formulae consists of the unknown parameters which are determined by the structure of the portfolio. As an alternative to known methods of estimation, a game-theory approach is also offered in the prior art, for instance: the actuary or insurance statistician knows bounds for the parameter, and determines the optimal premium for the least favorable case. The credibility theory also comprises a number of models for reserving for long-term effects. Included are a variety of reserving methods which, unlike the credibility formula, do not depend upon unknown parameters. Here, too, the prior art comprises methods by stochastic models which describe the generation of the data. A series of results exist above all for the chain-ladder method as one of the best known methods for calculating outstanding payment claims and/or for extrapolation of the damage events. The strong points of the chain-ladder method are its simplicity, on the one hand, and, on the other hand, that the method is nearly distribution-free, i.e., the method is based on almost no assumptions. Distribution-free or non-parametric methods are particularly suited to cases in which the user can give insufficient details or no details at all concerning the distribution to be expected (e.g., Gaussian distribution, etc.) of the parameter to be developed.

The chain-ladder method means that of an event or loss P_{if} with f=1, 2, . . . , Fᵢ from incidence year i=1, . . . ,I, values P_{ikf} are known, wherein P_{ikf} may be, e.g., the payment status or the reserve status at the end of each handling year k=1, . . . ,K. Therefore, an event P_{if} consists in this case in a sequence of dots
P_{if}=(P_{i1f}, P_{i2f}, . . . , P_{jKf})

of which the first K+1−i dots are known, and the yet unknown dots (P_{i,K+2-1,f}, . . . , P_{i,K,f}) are to be predicted. The values of the events P_{if} form a so-called loss triangle or, more generally, an event-values triangle

$$( \begin{matrix}{P}_{11 f = 1 … {F}_{1}} & {P}_{12 f = 1 … {F}_{1}} & {P}_{13 f = 1 … {F}_{1}} & {P}_{14 f = 1 … {F}_{1}} & {P}_{15 f = 1 … {F}_{1}} \\ {P}_{21 f = 1 … {F}_{2}} & {P}_{22 f = 1 … {F}_{2}} & {P}_{23 f = 1 … {F}_{2}} & {P}_{24 f = 1 … {F}_{2}} & \\ {P}_{31 f = 1 … {F}_{3}} & {P}_{32 f = 1 … {F}_{3}} & {P}_{33 f = 1 … {F}_{3}} & & \\ {P}_{41 f = 1 … {F}_{4}} & {P}_{42 f = 1 … {F}_{4}} & & & \\ {P}_{51 f = 1 … {F}_{5}} & & & & \end{matrix} )$$

The lines and columns are formed by the damage-incidence years and the handling years. Generally speaking, e.g., the lines show the initial years, and the columns show the development years of the examined events, it also being possible for the presentation to be different from that. Now, the chain-ladder method is based upon the cumulated loss triangles, the entries Cᵢⱼ of which are, e.g., either mere loss payments or loss expenditures (loss payments plus change in the loss reserves). Valid for the cumulated array elements Cᵢⱼ is

$${C}_{ij} = {\sum }_{f = 1}^{{F}_{i}} {P}_{ijf}$$

from which follows

$$( \begin{matrix}{\sum }_{f = 1}^{{F}_{1}} {P}_{11 f} & {\sum }_{f = 1}^{{F}_{1}} {P}_{12 f} & {\sum }_{f = 1}^{{F}_{1}} {P}_{13 f} & {\sum }_{f = 1}^{{F}_{1}} {P}_{14 f} & {\sum }_{f = 1}^{{F}_{1}} {P}_{15 f} \\ {\sum }_{f = 1}^{{F}_{2}} {P}_{21 f} & {\sum }_{f = 1}^{{F}_{2}} {P}_{22 f} & {\sum }_{f = 1}^{{F}_{2}} {P}_{23 f} & {\sum }_{f = 1}^{{F}_{2}} {P}_{24 f} & \\ {\sum }_{f = 1}^{{F}_{3}} {P}_{31 f} & {\sum }_{f = 1}^{{F}_{3}} {P}_{32 f} & {\sum }_{f = 1}^{{F}_{3}} {P}_{33 f} & & \\ {\sum }_{f = 1}^{{F}_{4}} {P}_{41 f} & {\sum }_{f = 1}^{{F}_{4}} {P}_{42 f} & & & \\ {\sum }_{f = 1}^{{F}_{5}} {P}_{51 f} & & & & \end{matrix} )$$

From the cumulated values interpolated by means of the chain-ladder method, the individual event can also again be judged in that a certain distribution, e.g., typically a Pareto distribution, of the values is assumed. The Pareto distribution is particularly suited to insurance types such as, e.g., insurance of major losses or reinsurers, etc. The Pareto distribution takes the following form

$$Θ ( x ) = 1 - {( \frac{x}{T} )}^{α}$$

wherein T is a threshold value, and α is the fit parameter. The simplicity of the chain-ladder method resides especially in the fact that for application it needs no more than the above loss triangle (cumulated via the development values of the individual events) and, e.g., no information concerning reporting dates, reserving procedures, or assumptions concerning possible distributions of loss amounts, etc. The drawbacks of the chain-ladder method are sufficiently known in the prior art (see, e.g., Thomas Mack, Measuring the Variability of Chain Ladder Reserve Estimates, submitted CAS Prize Paper Competition 1993, Greg Taylor, Chain Ladder Bias, Centre for Actuarial Studies, University of Melbourne, Australia, March 2001, pp 3). In order to obtain a good estimate value, a sufficient data history is necessary. In particular, the chain-ladder method proves successful in classes of business such as motor vehicle liability insurance, for example, where the differences in the loss years are attributable in great part to differences in the loss frequencies since the appraisers of the chain-ladder method correspond to the maximum likelihood estimators of a model by means of modified Poisson distribution. Hence caution is advisable, e.g., in the case of years in which changes in the loss amount distribution are made (e.g., an increase in the maximum liability sum or changes in the retention) since these changes may lead to structural failures in the chain-ladder method. In classes of business having extremely long run-off time—such as general liability insurance—the use of the chain-ladder method likewise leads in many cases to usable results although data, such as a reliable estimate of the final loss quota, for example, are seldom available on account of the long run-off time. However, the main drawback of the chain-ladder method resides in the fact that the chain-ladder method is based upon the cumulated loss triangle, i.e., through the cumulation of the event values of the events having the same initial year, essential information concerning the individual losses and/or events is lost and can no longer be recovered later on.

Known in the prior art is a method of T. Mack (Thomas Mack, Schriftreihe Angewandte Versicherungsmathematik, booklet 28, pp. 31Off., Verlag Versicherungswirtschaft E. V., Karlsruhe 1997) in which the values can be propagated, i.e., the values in the loss triangle can be extrapolated without loss of the information on the individual events. With the Mack method, therefore, using the complete numerical basis for each loss, an individual IBNER reserve can be calculated (IBNER: Incurred But Not Enough Reported). IBNER demands are understood to mean payment demands which are either over the predicted values or are still outstanding. The IBNER reserve is useful especially for experience rating of excess of loss reinsurance contracts, where the reinsurer, as a rule, receives the required individual loss data, at least for the relevant major losses. In the case of the reinsurer, the temporal development of a portfolio of risks describes through a risk process in which the damage figures and loss amounts are modeled, whereby in the excess of loss reinsurance, upon the transition from the original insurer to the reinsurer, the phenomenon of the accidental dilution of the risk process arises; on the other s hand, through reinsurance, portfolios of several original insurers are combined and risk processes thus caused to overlap. The effects of dilution and overlapping have, until now, been examined above all for Poisson risk processes. For insurance/reinsurance, experience rating by means of the Mack method means that of each loss P_{if}, with f=1,2, . . . ,Fᵢ from incidence year or initial lo year i=1, . . . ,I, the payment status Z_{ikf} and the reserve status R_{jkf} at the end of each handling year or development year k=1, . . . , K until the current status (Z_{i,K+1 -i,f}, R_{i,K+1-i,f}) is known. A loss P_{if} in this case therefore consists of a sequence of dots
P_{if}=(Z_{i1f}, R_{i1f}), (Z_{i2f}, R_{i2f}), . . . , (Z_{iKf}, R_{iKf})

at the payment reserve level, of which the first K+1−i dots are known, and the still unknown dots (Z_{i,K+2-i,f}, R_{i,K+2-i,f}), . . . , (Z_{i,K,f}, R_{i,K,f}) are supposed to be predicted. Of particular interest is, naturally, the final status (Z_{i,K,f}, R_{j,K,f}), R_{i,K,f} being equal to 0 in the ideal case, i.e., the claim is regarded as completely settled; whether this can be achieved depends upon the length K of the development period considered. In the prior art, as e.g. in the Mack method, a claim status (Z_{i,K+1-i,f}, R_{i,K+1-i,f}) is continued as was the case in similar claims from earlier incidence years. In the conventional methods, therefore, it must be determined, for one thing, when two claims are “similar,” and for another thing, what it means to “continue” a claim. Furthermore, besides the IBNER reserve thus resulting, it must be determined, in a second step, how the genuine belated claims are to be calculated, about which nothing is as yet known at the present time.

For qualifying the similarity, e.g., the Euclidean distance
d((Z,R), (\tilde{Z},\tilde{R}))={square root over ((Z−\tilde{Z})²+(R−\tilde{R})²

is used at the payment reserve level in the prior art. But also with the Euclidean distance there are many possibilities for finding for a given claim (P_{i,1,f}, P_{i,2,f, . . .} , P_{i,K+1-i,f}) the closest most similar claim of an earlier incidence year, i.e., the claim ˜P_{1, . . .} ,˜Pₖ) with k>K+1−i, for which either

$${\sum }_{j = 1}^{K + 1 - i} d ( {P}_{ijf} , {\tilde{P}}_{j} ) \text{(sum of all previous distances)}$$

$$or$$

$${\sum }_{j = 1}^{K + 1 - i} j \cdot d ( {P}_{ijf} , {\tilde{P}}_{j} ) \text{(weighted sum of all distances)}$$

$$or$$

$${max}_{1 \leq j \leq K + 1 - i} d ( {P}_{ijf} , {\tilde{P}}_{j} ) \text{(maximum distance)}$$

$$or$$

$$d ( {P}_{i , K + 1 - i , f} , {\tilde{P}}_{K + 1 - j} ) \text{(current distance)}$$

$$\text{is minimal.}$$

In the example of the Mack method, normally the current distance is used. This means that for a claim (P₁, . . . ,Pₖ), the handling of which is known up to the k-th development year, of all other claims (\tilde{P}ᵢ, . . . , \tilde{P}ⱼ), the development of which is known at least up to the development year j≧k+1, the one considered as the most similar is the one for which the current distance d(Pₖ,\tilde{P}ₖ) is smallest.

The claim (P₁, . . . ,Pₖ) is now continued as is the case for its closest-distance “model”(\tilde{P}₁, . . . , \tilde{P}ₖ, \tilde{P}ₖ₊₁, . . . , \tilde{P}ⱼ). For doing this, there is the possibility of continuing for a single handling year (i.e., up to Pₖ₊₁) or for several development years at the same time (e.g., up to Pⱼ). In methods such as the Mack method, for instance, one typically first continues for just one handling year in order to search then again for a new most similar claim, whereby the claim just continued is continued for a further development year. The next claim found may naturally also again be the same one. For continuation of the damage claims, there are two possibilities. The additive continuation of Pₖ=(Zₖ,Rₖ)
\hat{P}ₖ₊₁=(\hat{Z}ₖ₊₁,\hat{R}ₖ₊₁)=(Zₖ+\tilde{Z}ₖ₊₁−\tilde{P}ₖ,Rₖ+\tilde{R}ₖ₊₁−\tilde{R}ₖ),

and the multiplicative continuation of Pₖ=(Zₖ,Rₖ)

$${\hat{P}}_{k + 1} = ( {\hat{Z}}_{k + 1} , {\hat{R}}_{k + 1} ) = ( {Z}_{k} \cdot \frac{{\tilde{Z}}_{k + 1}}{{\tilde{Z}}_{k}} , {R}_{k} \cdot \frac{{\tilde{R}}_{k + 1}}{\tilde{R}} ) .$$

It is easy to see that one of the drawbacks of the prior art, especially of the Mack method, resides, among other things, in the type of continuation of the damage claims. The multiplicative continuation is useful only for so-called open claim statuses, i.e., Zₖ>0, Rₖ>0. In the case of probable claim statuses Pₖ=(0, Rₖ), Rₖ>0, the multiplicative continuation must be diversified since otherwise no continuation takes place. Moreover if \tilde{Z}ₖ=0 or \tilde{R}ₖ=0, a division by 0 takes place. Similarly, if \tilde{Z}ₖ or \tilde{R}kₖ is small, the multiplicative method may easily lead to unrealistically high continuations. This does not permit a consistent treatment of the cases. This means that the reserve Rₖ cannot be simply continued in this case. In the same way, an adjusted claim status Pₖ=(Zₖ, 0), Zₖ>0 can likewise not be further developed. One possibility is simply to leave it unchanged. However, a revival of a claim is thereby prevented. At best it could be continued on the basis of the closest adjusted model, which likewise does not permit a consistent treatment of the cases. Also with the additive continuation, probable claim statuses should meaningfully be continued only on the basis of a likewise probable model in order to minimize the Euclidean distance and to guarantee a corresponding qualification of the similarity. An analogous drawback arises in the case of adjusted claim statuses, if a revival is supposed to be allowed and negative reserves are supposed to be avoided. Quite generally, the additive method can easily lead to negative payments and/or reserves. In addition, in the prior art, a claim Pₖ cannot be continued if no corresponding model exists without further assumptions being inserted into the method. As an example thereof is an open claim Pₖ when in the same handling year k there is no claim from previous incidence years in which \tilde{P}ₖ is likewise open. A way out of the dilemma can be found in that, for this case, Pₖ is left unchanged, i.e. \hat{P}ₖ₊₁=Pₖ, which of course does not correspond to any true continuation.

Thus, all in all, in the prior art every current claim status P_{i,K+1-i,f}=(Z_{i,K+1-i,f}, R_{i,K+1-i,f}) is further developed step by step either additively or multiplicatively up to the end of development and/or handling after K-development years. Here, in each step, the nearest, according to the Euclidean distance in each case, model claim status of the same claim status type (probable, open, or adjusted) is ascertained, and the claim status to be continued is continued either additively or multiplicatively according to the further development of the model claim. For the Mack method, it is likewise sensible always to take into consideration as model only actually observed claim developments \tilde{P}ₖ→\tilde{P}ₖ₊₁ and no extrapolated, i.e., developed claim developments since otherwise a correlation and/or a corresponding bias of the events is not to be avoided. Conversely, however, the drawback is maintained that already known information of events is lost.

From the construction of the prior art methods it is immediately clear that the methods can also be applied separately, on the one hand to the triangle of payments, on the other hand to the triangle of reserves. Naturally, with the way of proceeding described, other possibilities could also be permitted in order to find the closest claim status as model in each case. However, this would have an effect particularly on the distribution freedom of the method. It may thereby be said that in the prior art, the above-mentioned systematic problems cannot be eliminated even by respective modifications, or at best only in that further model assumptions are inserted into the method. Precisely in the case of complex dynamically non-linear processes, however, as e.g. the development of damage claims, this is not desirable in most cases. Even putting aside the mentioned drawbacks, it must still always be determined, in the conventional method according to T. Mack, when two claims are similar and what it means to continue a claim, whereby, therefore, minimum basic assumptions and/or model assumptions must be made. In the prior art, however, not only is the choice of Euclidean metrics arbitrary, but also the choice between the mentioned multiplicative and additive methods. Furthermore, the estimation of error is not defined in detail in the prior art. It is true that it is conceivable to define an error, e.g., based on the inverse distance. However, this is not disclosed in the prior art. An important drawback of the prior art is also, however, that each event must be compared with all the previous ones in order to be able to be continued. The expenditure increases linearly with the number of years and linearly with the number of claims in the portfolio. When portfolios are aggregated, the computing effort and the memory requirement increase accordingly.

Neural networks are fundamentally known in the prior art, and are used, for instance, for solving optimization problems, image recognition (pattern recognition), in artificial intelligence, etc. Corresponding to biological nerve networks, a neural network consists of a plurality of network nodes, so-called neurons, which are interconnected via weighted connections (synapses). The neurons are organized in network layers (layers) and interconnected. The individual neurons are activated in dependence upon their input signals and generate a corresponding output signal. The activation of a neuron takes place via an individual weight factor by the summation over the input signals. Such neural networks are adaptive by systematically changing the weight factors as a function of given exemplary input and output values until the neural network shows a desired behavior in a defined, predictable error span, such as the prediction of output values for future input values, for example. Neural networks thereby exhibit adaptive capabilities for learning and storing knowledge and associative capabilities for the comparison of new information with stored knowledge. The neurons (network nodes) may assume a resting state or an excitation state. Each neuron has a plurality of inputs and just one output which is connected in the inputs of other neurons of the following network layer or, in the case of an output node, represents a corresponding output value. A neuron enters the excitation state when a sufficient number of the inputs of the neuron are excited over a certain threshold value of the neuron, i.e., if the summation over the inputs reaches a certain threshold value. In the weights of the inputs of a neuron and in the threshold value of the neuron, the knowledge is stored through adaptation. The weights of a neural network are trained by means of a learning process (see, e.g., G. Cybenko, “Approximation by Superpositions of a sigmoidal function,” Math. Control, Sig. Syst., 2, 1989, pp. 303-314; M. T. Hagan, M. B. Menjaj, “Training Feed-forward Networks with the Marquardt Algorithm,” IEEE Transactions on Neural Networks, Vol. 5, No. 6, pp. 989-993, November 1994; K. Hornik, M. Stinchcombe, H. White, “Multilayer Feed-forward Networks are Universal Approximators,” Neural Networks, 2, 1989, pp. 359-366, etc.).

It is a task of this invention to propose a new system and method for automated experience rating of events and/or loss reserving which does not exhibit the above-mentioned drawbacks of the prior art. In particular, an automated, simple, and rational method shall be proposed in order to develop a given claim further with an individual increase and/or factor so that subsequently all the information concerning the development of a single claim is available. With the method, as few assumptions as possible shall be made from the outset concerning the distribution, and at the same time the maximum possible information on the given cases shall be exploited.

According to the present invention, this goal is achieved in particular is by means of the elements of the independent claims. Further advantageous embodiments follow moreover from the dependent claims and the description.

In particular, these goals are achieved by the invention in that development values P_{i,k,f} having development intervals k=1, . . . ,K are assigned to a certain event P_{i,f} of an initial time interval i, wherein K is the last known development interval is, with i=1, . . . ,K, and for the events P_{1,f} all development values P_{1kf} are known, at least one neural network being used for determining the development values P_{i,K+2-i,f, . . .} , P_{iKf}. In the case of certain events, e.g., the initial time interval can be assigned to an initial year, and the development intervals can be assigned to development years. The development values P_{ikf} of the various events P_{i,f} can, according to their initial time interval, be scaled by means of at least one scaling factor. The scaling of the development values P_{ikf} has the advantage, among others, that the development values are comparable at differing points in time. This variant embodiment further has the advantage, among others, that for the automated experience rating no model assumptions need be presupposed, e.g. concerning value distributions, system dynamics, etc. In particular, the experience rating is free of proximation preconditions, such as the Euclidean measure, etc., for example. This is not possible in this way in the prior art. In addition, the entire information of the data sample is used, without the data records' being cumulated. The complete information concerning the individual events is kept in each step, and can be called up again at the end. The scaling has the advantage that data records of differing initial time intervals receive comparable orders of magnitude, and can thus be better compared.

In one variant embodiment, for determining the development values P_{i,K-(i-j)+1,f} (i−1) neural networks Nᵢⱼ are generated iteratively with j=1, . . . ,(i−1) for each initial time interval and/or initial year i, the neural network N_{i,j+1} depending recursively on the neural network Nᵢⱼ. For weighting a certain neural network N_{i,j}, the development values P_{p,q,f} can be used, for example, with p=1, . . . ,(i−1) and q=1, . . . ,K−(i−j). This variant embodiment has the advantage, among others, that, as in the preceding variant embodiment, the entire information of the data sample is used, without the data records' being cumulated. The complete information concerning the individual events is maintained in each step, and can be called up again at the end. By means of a minimizing of a globally introduced error, the networks can be additionally optimized.

In another variant embodiment, the neural networks N_{i,j} are identically trained for identical development years and/or development intervals j, the neural network N_{i+1,j=i} being generated for an initial time interval and/or initial year i+1, and all other neural networks N_{i+1,j<i} being taken over from previous initial time intervals and/or initial years. This variant embodiment has the advantage, among others, that only known data are used for the experience rating, and certain data are not used further by the system, whereby the correlation of the errors or respectively of the data is prevented.

In a still different variant embodiment, events P_{i,f} with initial time interval i<1 are additionally used for determination, all development values P_{i<1,k,f} for the events P_{i<1,f} being known. This variant embodiment has the advantage, among others, that by means of the additional data records the neural networks can be better optimized, and their errors can be minimized.

In a further variant embodiment, for the automated experience rating and/or loss reserving, development values P_{i,k,f} with development intervals k=1, . . . ,K are stored assigned to a certain event P_{i,f} of an initial time interval i, in which i=1, . . . ,K, and K is the last known development interval, and in which for the first initial time interval all development values P_{1,k,f} are known, for each initial time interval i=2, . . . ,K by means of iterations j=1 , . . . (i−1) upon each iteration j in a first step a neural network Nᵢⱼ being generated having an input layer with K−(i−j) input segments and an output layer, which input segments comprise at least one input neuron and are assigned to a development value P_{i,k,f}, in a second step the neural network N_{i,j} with the available events P_{i,f} of all initial time intervals m=1 . . . ,(i−1) being weighted by means of the development values P_{m,1 . . . K-(i-j),f} as input and P_{m,1 . . . K-(i-j)+1,f} as output, and in a third step by means of the neural network N_{i,j} the output values O_{i,f} being determined for all events P_{i,f} of the initial time interval i, the output value O_{i,f} being assigned to the development value P_{i,K-(i-j)+1,f} of the event P_{i,f}, and the neural network Nᵢⱼ being dependent recursively on the neural network N_{i,j+1}. In the case of certain events, e.g., the initial time interval can be assigned to an initial year, and the development intervals assigned to development years. This variant embodiment has the same advantages, among others, as the preceding variant embodiments.

In one variant embodiment, a system comprises neural networks Nᵢ each having an input layer with at least one input segment and an output layer, which input and output layer comprises a plurality of neurons which are interconnected in a weighted way, the neural networks Nᵢ being iteratively producible by means of a data processing unit through software and/or hardware, a neural network Nᵢ₊₁ depending recursively on the neural network Nᵢ, and each network Nᵢ₊₁ comprising in each case one input segment more than the network Nᵢ, each neural network Nᵢ, beginning with the neural network N₁, being trainable by means of a minimization module through minimizing of a locally propagated error, and the recursive system of neural networks being trainable by means of a minimization module through minimization of a globally propagated error based upon the local errors of the neural networks Nᵢ. This variant embodiment has the advantage, among others, that the recursively generated neural networks can be additionally optimized by means of the global error. Among other things, it is the combination of the recursive generation of the neural network structure with a double minimization by means of locally propagated error and globally propagated error which results in the advantages of the variant embodiment.

In another variant embodiment, the output layer of the neural network Nᵢ is connected in an assigned way to at least one input segment of the input layer of the neural network Nᵢ₊₁. This variant embodiment has the advantage, among others, that the system of neural networks can in turn be interpreted as a neural network. Thus partial networks of a whole network may lo be locally weighted, and also in the case of global learning can be checked and monitored in their behavior by the system by means of the corresponding data records. This has not been possible until now in this way in the prior art.

At this point, it shall be stated that besides the method according to the invention, the present invention also relates to a system for carrying out this method. Furthermore, it is not limited to the said system and method, but equally relates to recursively nested systems of neural networks and a computer program product for implementing the method according to the invention.

Variant embodiments of the present invention are described below on the basis of examples. The examples of the embodiments are illustrated by the following accompanying figures:

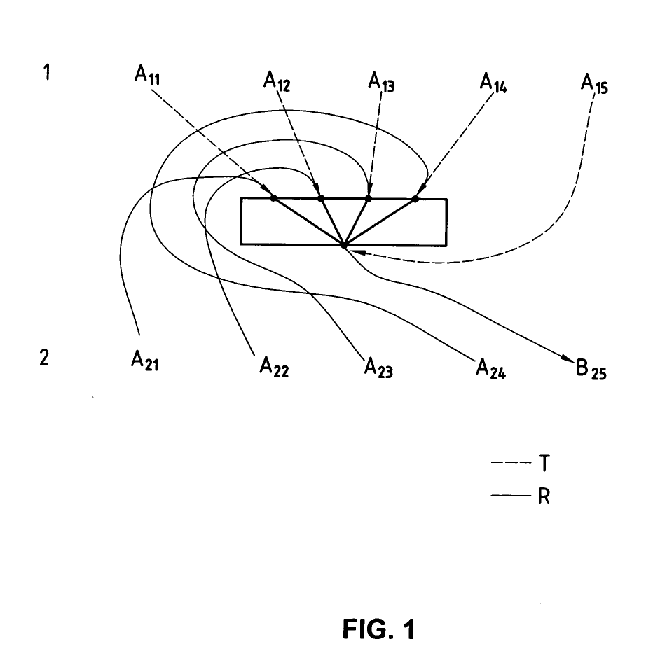

FIG. 1 shows a block diagram which reproduces schematically the training and/or determination phase or presentation phase of a neural network for determining the event value P_{2,5,f} of an event P_{f} in an upper 5×5 matrix, i.e., with K=5. The dashed line T indicates the training phase, and the solid line R the determination phase after learning.

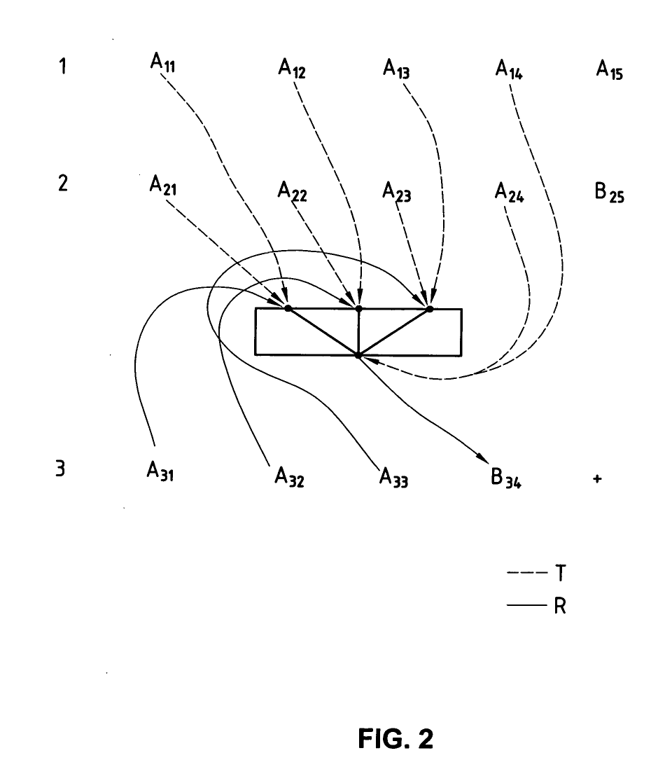

FIG. 2 likewise shows a block diagram which, like FIG. 1, reproduces schematically the training and/or determination phase of a neural network for determining the event value P_{3,4,f} for the third initial year.

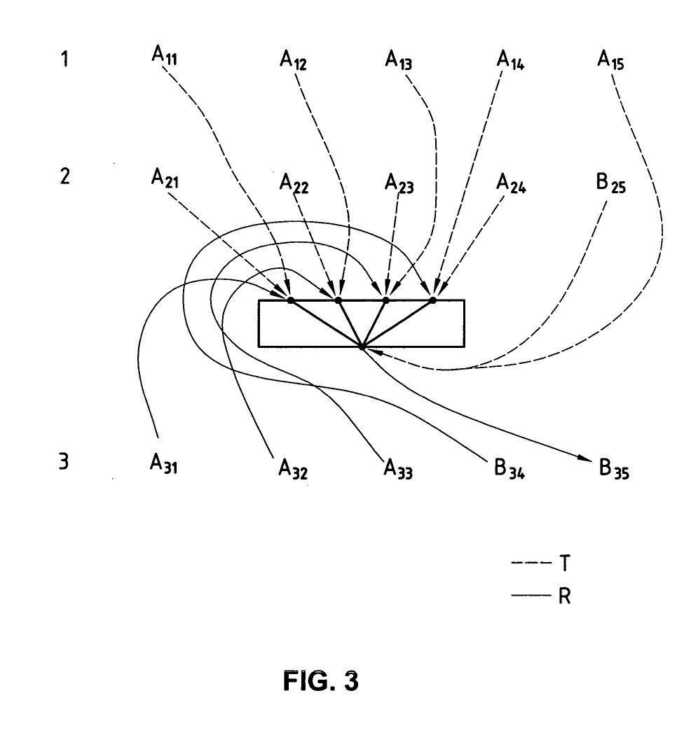

FIG. 3 shows a block diagram which, like FIG. 1, reproduces schematically the training and/or determination phase of a neural network for determining the event value P_{3,5,f} for the third initial year.

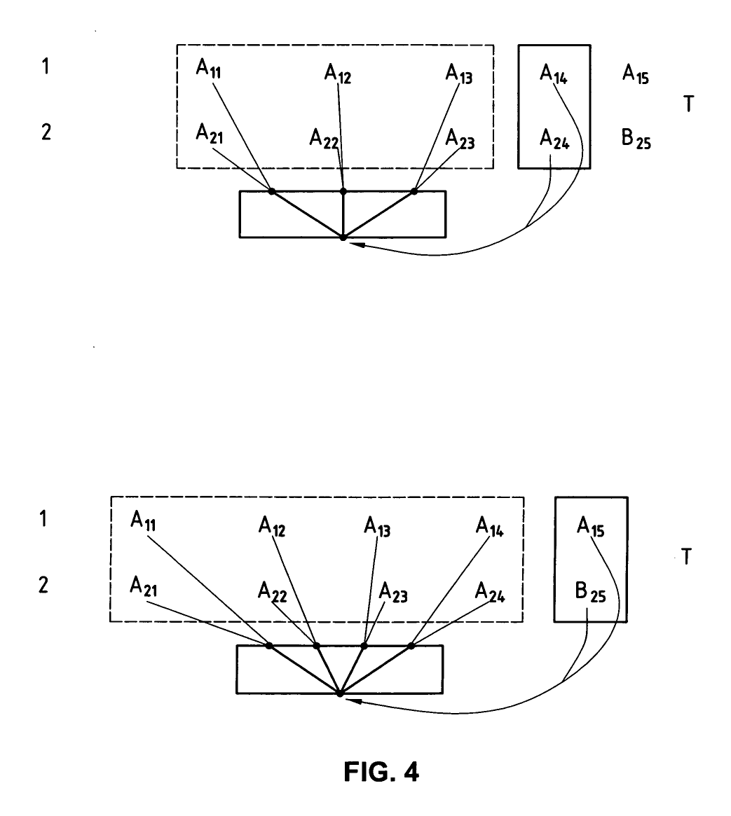

FIG. 4 shows a block diagram which schematically shows only the training phase for determining P_{3,4,f} and P_{3,5,f}, the calculated values P_{3,4,f} being used for training the network for determining P_{3,5,f}.

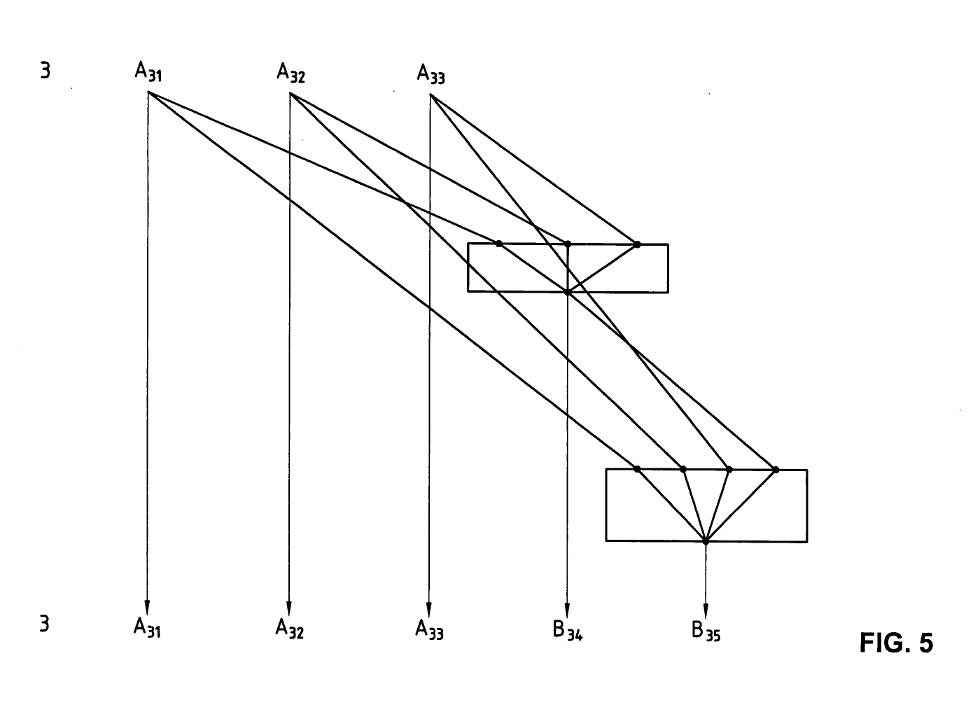

FIG. 5 shows a block diagram which schematically shows the recursive generation of neural networks for determining the values in line 3 of a 5×5 matrix, two networks being generated.

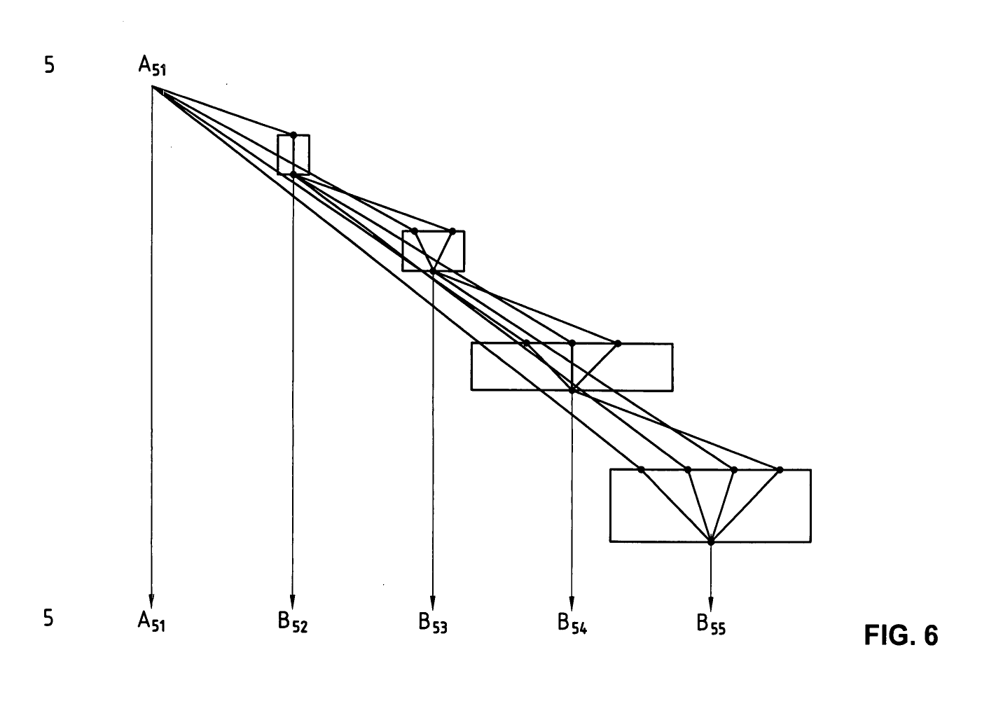

FIG. 6 shows a block diagram which schematically shows the recursive generation of neural networks for determining the values in line 5 of a 5×5 matrix, four networks being generated.

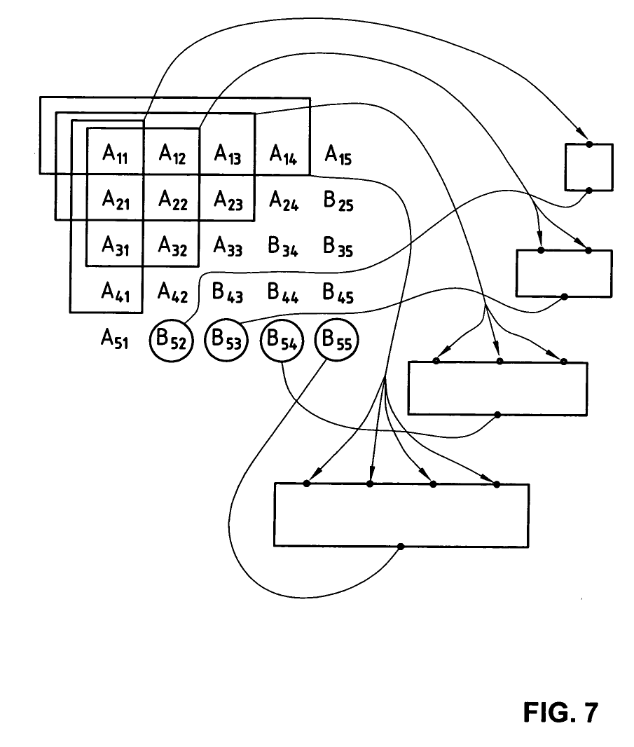

FIG. 7 shows a block diagram which likewise shows schematically a system according to the invention, the training basis being restricted to the known event values Aᵢⱼ.

FIGS. 1 to 7 illustrate schematically an architecture which may be used for implementing the invention. In this embodiment example, a certain event P_{i,f} of an initial year i includes development values P_{ikf} for the automated experience rating of events and/or loss reserving. The index f runs over all events P_{i,f} for a certain initial year i with f=1, . . . ,Fⱼ. The development value P_{ikf}=(Z_{ikf},R_{ikf}, . . . ) is any vector and/or n-tuple of development parameters Z_{ikf}, R_{ikf}, . . . , which is supposed to be developed for an event. Thus, for example, in the case of insurance for a damage event P_{ikf}, Z_{ikf} can be the payment status, R_{ikf} the reserve status, etc. Any desired further relevant parameters for an event are conceivable without this affecting the scope of protection of the invention. The development years k proceed from k=1, . . . ,K, and the initial years I=1, . . . , I. K is the last known development year. For the first initial year i=1, all development values P_{1kf} are given. As already indicated, for this example the number of initial years I and the number of development years K are supposed to be the same, i.e., I=K. However, it is quite conceivable that I≠K, without the method or the system being thereby limited. P_{ikf} is therefore an n-tuple consisting of the sequence of dots and/or matrix elements
(Zᵢₖₙ, Rᵢₖₙ, . . . ) with k=1, 2, . . . , K

With I=K the result is thereby a quadratic upper triangular matrix and/or block triangular matrix for the known development values P_{ikf}

$$( \begin{matrix}{P}_{11 f = 1 … {F}_{1}} & {P}_{12 f = 1 … {F}_{1}} & {P}_{13 f = 1 … {F}_{1}} & {P}_{14 f = 1 … {F}_{1}} & {P}_{15 f = 1 … {F}_{1}} \\ {P}_{21 f = 1 … {F}_{2}} & {P}_{22 f = 1 … {F}_{2}} & {P}_{23 f = 1 … {F}_{2}} & {P}_{24 f = 1 … {F}_{2}} & \\ {P}_{31 f = 1 … {F}_{3}} & {P}_{32 f = 1 … {F}_{3}} & {P}_{33 f = 1 … {F}_{3}} & & \\ {P}_{41 f = 1 … {F}_{4}} & {P}_{42 f = 1 … {F}_{4}} & & & \\ {P}_{51 f = 1 … {F}_{5}} & & & & \end{matrix} )$$

again with f=1, . . . ,Fᵢ going over all events for a certain initial year. Thus, the lines of the matrix are assigned to the initial years and the columns of the matrix to the development years. In the embodiment example, P_{ikf} shall be limited to the example of damage events with insurance since in particular the method and/or the system is very suitable, e.g., for the experience rating of insurance contracts and/or excess loss reinsurance contracts. It must be emphasized that the matrix elements P_{ikf} may themselves again be vectors and/or matrices, whereupon the above matrix becomes a corresponding block matrix. The method and system according to the invention is, however, suitable for experience rating and/or for extrapolation of time-delayed non-linear processes quite generally. That being said, P_{ikf} is a sequence of dots
(Zᵢₖₙ, Rᵢₖₙ, . . . ) with k=1, 2, . . . , K

at the payment reserve level, the first K+1−i dots of which are known, and the still unknown dots (Z_{i,K+2-i,f}, R_{i,K+2-i,f}), . . . , (Z_{iKf}, R_{iKf}), are supposed to be predicted. If, for this example, P_{ikf} is divided into payment level and reserve level, the result obtained analogously for the payment level is the triangular matrix

$$( \begin{matrix}{Z}_{11 f} & {Z}_{12 f} & {Z}_{13 f} & {Z}_{14 f} & {Z}_{15 f} \\ {Z}_{21 f} & {Z}_{22 f} & {Z}_{23 f} & {Z}_{24 f} & \\ {Z}_{31 f} & {Z}_{32 f} & {Z}_{33 f} & & \\ {Z}_{41 f} & {Z}_{42 f} & & & \\ {Z}_{51 f} & & & & \end{matrix} )$$

and for the reserve level the triangular matrix

$$( \begin{matrix}{R}_{11 f} & {R}_{12 f} & {R}_{13 f} & {R}_{14 f} & {R}_{15 f} \\ {R}_{21 f} & {R}_{22 f} & {R}_{23 f} & {R}_{24 f} & \\ {R}_{31 f} & {R}_{32 f} & {R}_{33 f} & & \\ {R}_{41 f} & {R}_{42 f} & & & \\ {R}_{51 f} & & & & \end{matrix} )$$

Thus, in the experience rating of damage events, the development of each individual damage event fᵢ is known from the point in time of the report of damage in the initial year i until the current status (current development year k) or until adjustment. This information may be stored in a database, which database may be called up, e.g., via a network by means of a data processing unit. However, the database may also be accessible directly via an internal data bus of the system according to the invention, or be read out otherwise.

In order to use the data in the example of the claims, the triangular matrices are scaled in a first step, i.e., the damage values must first be made comparable in relation to the assigned time by means of the respective inflation values. The inflation index may likewise be read out of corresponding databases or entered in the system by means of input units. The inflation index for a country may, for example, look like the following:

| Year | Inflation Index (%) | Annual Inflation Value |
|---|---|---|
| 1989 | 100 | 1.000 |
| 1990 | 105.042 | 1.050 |
| 1991 | 112.920 | 1.075 |
| 1992 | 121.429 | 1.075 |
| 1993 | 128.676 | 1.060 |
| 1994 | 135.496 | 1.053 |
| 1995 | 142.678 | 1.053 |
| 1996 | 148.813 | 1.043 |
| 1997 | 153.277 | 1.030 |
| 1998 | 157.109 | 1.025 |
| 1999 | 163.236 | 1.039 |
| 2000 | 171.398 | 1.050 |
| 2001 | 177.740 | 1.037 |
| 2002 | 185.738 | 1.045 |

Further scaling factors are just as conceivable, such as regional dependencies, ect., for example. If damage events are compared and/or extrapolated in more than one country, respective national dependencies are added. For the general, non-insurance-specific case, the scaling may also related to dependencies such as e.g. mean age of populations of living beings, influences of nature, etc. etc.

For the automated determination of the development values P_{i,K+2-i,f, . . . ,} P_{i,K,f}=(Z_{i,K+2-i,f}, R_{i,K+2-i,K,f}), . . . , (Z_{i,K,f}, R_{i,K,f}), the system and/or method comprises at least one neural network. As neural networks, e.g., conventional static and/or dynamic neural networks may be chosen, such as, for example, feed-forward (heteroassociative) networks such as a perceptron or a multi-layer preceptron (MLP), but also other network structures, such as, e.g., recurrent network structures, are conceivable. The differing network structure of the feed-forward networks in contrast to networks with feedback (recurrent networks) determines the way in which information is processed by the network. in the case of a static neural network, the structure is supposed to ensure the replication of satic characteristic fields with sufficient approximation quality. For this embodiment example let multilayer perceptrons be chosen as an example. An MLP consists of a number of neuron layers having at least one input layer and one output layer. The structure is directed strictly forward, and belongs to the group of feed-forward networks. Neural networks quite generally map an m-dimensional input signal onto an n-dimensional output signal. The information to be processed is, in the feed-forward network considered here, received by a layer having input neurons, the input layer. The input neurons process the input signals, and forward them via weighted connections, so-called synapses, to one or more hidden neuron layers, the hidden layers. From the hidden layers, the signal is transmitted, likewise by means of weighted synapses, to neurons of an output layer which, in turn, generate the output signal of the neural network. In a forward directed, completely connected MLP, each neuron of a certain layer is connected to all neurons of the following layer. The choice of the number of layers and neurons (network nodes) in a particular layer is, as usual, to be adapted to the respective problem. The simplest possibility is to find out the ideal network structure empirically. In so doing, it is to be heeded that if the number of neurons chosen is too large, the network, instead of learning, works purely image-forming, while with too small a number of neurons it comes to correlations of the mapped parameters. Expressed differently, the fact is that if the number of neurons chosen is too small, the function can possibly not be represented. However, upon increasing the number of hidden neurons, the number of independent variables in the error function also increases. This leads to more local minima and to the greater probability of landing in precisely one of these minima. In the special case of back propagation, this problem can be at least minimized, e.g. by means of simulated annealing. In simulated annealing, a probability is assigned to the states of the network. In analogy to the cooling of liquid material from which crystals are produced, a high initial temperature T is chosen. This is gradually reduced, the lower the slower. In analogy to the formation of crystals from liquid, it is assumed that if the material is allowed to cool too quickly, the molecules do not arrange themselves according to the grid structure. The crystal becomes impure and unstable at the locations affected. In order to present this, the material is allowed to cool down so slowly that the molecules still have enough energy to jump out of local minimum. In the case of neural networks, nothing different is done: additionally, the magnitude T is introduced in a slightly modified error function. In the ideal case, this then converges toward a global minimum.

For the application to experience rating, neural networks having an at least three-layered structure have proved useful in MLP. That means that the networks comprise at least one input layer, a hidden layer, and an output layer. Within each neuron, the three processing steps of propagation, activation, and output take place. As output of the i-th neuron of the k-th layer there results

$${o}_{i}^{k} = {f}_{i}^{k} ( {\sum }_{j} {w}_{i , j}^{k} \cdot {o}_{i , j}^{k - 1} + {b}_{i , j}^{k} )$$

whereby e.g. for k=2, as range of the controlled variable j=1,2, . . . ,N₁ is valid; designated with N₁ is the number of neurons of the layer k−1, w as weight, and b as bias (threshold value). Depending upon the application, the bias b may be chosen the same or different for all neurons of a certain layer. As activation function, e.g., a log-sigmoidal function may be chosen, such as

$${f}_{i}^{k} ( ξ ) = \frac{1}{1 + {ⅇ}^{- ξ}}$$

The activation function (or transfer function) is inserted in each neuron. Other activation functions such as tangential functions, etc., are, however, likewise possible according to the invention. With the back-propagation method, however, it is to be heeded that a differentiable activation function <is used>, such as e.g. a sigmoid function, since this is a prerequisite for the method. That is, therefore, binary activation function as e.g.

$$f ( x ) := \{ \begin{matrix}1 if x > 0 \\ 0 if x \leq 0\end{matrix}$$

do not work for the back-propagation method. In the neurons of the output layer, the outputs of the last hidden layer are summed up in a weighted way. The activation function of the output layer may also be linear. The entirety of the weightings W_{i,j}^{k} and bias B_{i,j}^{k} combined in the parameter—and/or weighting matrices determine the behavior of the neural network structure
W^{k}=(w_{i,j}^{k})εR^{N·N}^{ₖ}

Thus the result is
o^{k}=B^{k}+W^{k}·(1+e^{-(B}^{^{k−1}}^{+W}^{^{k−1}}^{·u)})⁻¹

The way in which the network is supposed to map an input signal onto an output signal, i.e., the determination of the desired weights and bias of the network, is achieved by training the network by means of training patterns. The set of training patterns (index μ) consists of the input signal and an output signal
Y^{μ}=└y₁^{μ}, y₂^{μ}, . . . ,y_{N}_{₁}^{μ}┘

and an output signal
U^{μ}=└u₁^{μ}, u₂^{μ}, . . . ,u_{N}_{₁}^{μ}┘

In this embodiment example with the experience rating of claims, the training patterns comprise the known events P_{i,f} with the known development values P^{ikf} for all k, f, and i. Here the development values of the events to be extrapolated may naturally not be used for training the neural networks since the output value corresponding to them is lacking.

At the start of the learning operation, the initialization of the weights of the hidden layers, thus in this exemplary example of the neurons, is carried out, e.g., by means of a log-sigmoidal activation function, e.g. according to Nguyen-Widrow (D. Nguyen, B. Widrow, “Improving the Learning Speed of 2-Layer Neural Networks by Choosing Initial Values of Adaptive Weights,” International Joint Conference of Neural Networks, Vol. 3, pp. 21-26, July 1990). If a linear activation function has been chosen for the neurons of the output layer, the weights may be initialized, e.g., by means of a symmetrical random number generator. For training the network, various prior art learning methods may be used, such as e.g. the back-propagation method, learning vector quantization, radial basis function, Hopfield algorithm, or Kohonen algorithm, etc. The task of the training method consists in determining the synapses weights w_{i,j} and bias b_{i,j} within the weighting matrix W and/or the bias matrix B in such a way that the input patterns Y^{μ} are mapped onto the corresponding output patterns U^{μ}. For judging the learning stage, the absolute quadratic error

$$Err = \frac{1}{2} {\sum }_{μ = 1}^{p} {\sum }_{λ = 1}^{m} {( {u}_{eff , λ}^{μ} - {u}_{soll , λ}^{μ} )}^{2} = {\sum }_{μ = 1}^{p} {Err}^{μ}$$

may be used, for example. The error Err then takes into consideration all patterns P_{ikf} of the training basis in which the actual output signals U_{eff}^{μ} show the target reactions Uₛₒₗₗ^{μ} specified in the training basis. For this embodiment example, the back-propagation method shall be chosen as the learning method. The back-propagation method is a recursive method for optimizing the weight factors wᵢⱼ. In each learning step, an input pattern Y^{μ} is randomly chosen and propagated through the network (forward propagation). By means of the above-described error function Err, the error Err^{μ} on the presented input pattern is determined from the output signal generated by the network by means of the target reaction Uₛₒₗₗ^{μ} specified in the training basis. The modifications of the individual weights wᵢⱼ after the presentation of the μ-th training pattern are thereby proportional to the negative partial derivation of the error Err^{μ} according to the weight wᵢⱼ (so-called gradient descent method)

$$Δ {w}_{i , j}^{μ} \approx \frac{\partial {E}^{μ}}{\partial {w}_{i , j}}$$

With the aid of the chain rule, the known adaptation specifications, known as back-propagation rule, for the elements of the weighting matrix in the presentation of the μ-th training pattern can be derived from the partial derivation.
Δw_{i,j}^{μ}≡s·δᵢ^{μ}·u_{eff,j}^{μ}
with
δᵢ^{μ}=f¹(ξᵢ^{μ})·(u_{soll,i}^{μ}−u_{eff,1}⁸² )

for the output layer, and

$${δ}_{i}^{μ} = {f}^{1} ( {ξ}_{i}^{μ} ) \cdot {\sum }_{k}^{K} {δ}_{k}^{μ} {w}_{k , i}$$

for the hidden layers, respectively. Here the error is propagated through the network in the opposite direction (back propagation) beginning with the output layer and divided among the individual neurons according to the costs-by-cause principle. The proportionality factor s is called the learning factor. During the training phase, a limited number of training patterns is presented to a neural network, which patterns characterize precisely enough the map to be learned. In this embodiment example, with the experience rating of damage events, the training patterns may comprise all known events P_{i,f} with the known development values P_{ikf} for all k, f, and i. But a selection of the known events P_{i,f} is also conceivable. If thereafter the network is presented with an input signal which does not agree exactly with the patterns of the training basis, the network interpolates or extrapolates between the training patterns within the scope of the learned mapping function. This property is called the generalization capability of the networks. It is characteristic of neural networks that neural networks possess good error tolerance. This is a further advantage as compared with the prior art systems. Since neural networks map a plurality of (partially redundant) input signals upon the desired output signal(s), the networks prove to be robust toward the failure of individual input signals and/or toward signal noise. A further interesting property of neural networks is their adaptive capability. Hence it is possible in principle to have a once-trained system relearn or adapt permanently/periodically during operation, which is likewise an advantage as compared with the prior art systems. For the learning method, other methods may naturally also be used, such as e.g. a method according to Levenberg-Marquardt (D. Marquardt, “An Algorithm for least square estimation of non-linear Parameters,” J.Soc.Ind.Appl.Math., pp. 431-441, 1963, as well as M. T. Hagan, M. B. Menjaj, “Training Feed-forward Networks with the Marquardt Algorithm,” IEEE—Transactions on Neural Networks, Vol. 5, No. 6, pp.989-993, November 1994). The Levenberg-Marquardt method is a combination of the gradient method and the Newton method, and has the advantage that it converges faster than the above-mentioned back-propagation method, but needs a greater storage capacity during the training phase.

In the embodiment example, for determining the development values P_{i,K-(i-j)+1,f} for each initial year i (i−1) neural networks N_{i,j} are generated iteratively. j indicates, for a certain initial year i, the number of iterations, with j=1, . . . ,(i−1). Thereby, for the i-st initial year i−1, neural networks N_{i,j} are generated. The neural network Nᵢⱼ₊₁ depends recursively here from the neural network N_{i,j}. For weighting, i.e., for training, a certain neural network N_{i,j}, e.g., all development values P_{p,q,f} with p=1, . . . ,(i−1) and q=1, . . . ,K−(i−j) of the events or losses P_{pq} may be used. A limited selection may also be useful, however, depending upon the application. The data of the events P_{pq} may, for instance, as mentioned be read out of a database and presented to the system via a data processing unit. A calculated development value P_{i,k,f} may, e.g., be assigned to the respective event P_{i,f} of an initial year i and itself be presented to the system for determining the next development value (e.g., P_{i,k+1,f}) (FIGS. 1 to 6), or the assignment takes place only after the end of the determination of all development values P sought (FIG. 7).

In the first case (FIGS. 1 to 6), as described, development values P_{i,k,f} with development year k=1 , . . . ,K are assigned to a certain event P_{i,f} of an initial year i, whereby for the initial years i=1, . . . ,K, and K are the last known development year. For the first initial year i=1, all development values P_{1,k,f} are known. For each initial year i=2, . . . ,K by means of iterations j=1, . . . ,(i−1), upon each iteration j, in a first step, a neural network N_{i,j} is generated with an input layer with K−(i,j) input segments and an output layer. Each input segment comprises at least one input neuron and/or at least as many input neurons to obtain the input signal for a development value P_{i,k,f}. The neural networks are automatically generated by the system, and may be implemented by means of hardware or software. In a second step, the neural network Nᵢⱼ with the available events E_{i,f} of all initial years m=1, . . . ,(i−1) are weighted by means of the development values P_{m,1 . . . K-(i-j),f} as input and P_{m,1 . . . K-(i-j)+1,f} as output. In a third step, by means of the neural network N_{i,j}, the output values O_{i,f} are determined for all events P_{i,f} of the initial year i, the output value O_{i,f} being assigned to the development value P_{i,K-(i-j)+1,f} of the event P_{i,f}, and the neural network N_{i,j} depending recursively on the neural network N_{i,j+1}. FIG. 1 shows the training and/or presentation phase of a neural network for determining the event value P_{2,5,f} of an event P_{f} in an upper 5×5 matrix, i.e., at K+5. The dashed line T indicates the training phase, and the solid line R indicates the determination phase after learning. FIG. 2 shows the same thing for the third initial year for determining P_{3,4,f} (B₃₄), and FIG. 3 for determining P_{3,5,f}. FIG. 4 shows only the training phase for determining P_{3,4,f} and P_{3,5,f}, the generated values P_{3,4,f} (B₃₄) being used for training the network for determining P_{3,5,f·}. Aᵢⱼ indicates the known values in the figures, while Bᵢⱼ displays certain values by means of the networks. FIG. 5 shows the recursive generation of the neural networks for determining the values in line 3 of a 5×5 matrix, i−1 networks being generated, thus two. FIG. 6, on the other hand, shows the recursive generation of the neural networks for determining the values in line 3 of a 5×5 matrix, i−1 networks again being generated, thus four.

It is important to point out that, as an embodiment example, the assignment of the event values Bᵢⱼ generated by means of the system may also take place only after determination of all sought development values P. The newly determined values are then not available as input values for determination of further event values. FIG. 7 shows such a method, the training basis being limited to the known event values Aᵢⱼ. In other words, the neural networks Nᵢⱼ may be identical for the same j, the neural network N_{i+1,j=i} being generated for an initial time interval i+1, and all other neural networks N_{i+1,j<i} corresponding to networks of earlier initial time intervals. This means that a network, which was once generated for calculation of a particular event value Pᵢⱼ, is further used for all event values with an initial year a>i for the values Pᵢⱼ with same j.

In the case of the insurance cases discussed here, different neural networks may be trained, e.g. based on different data. For example, the networks may be trained based on the paid claims, based on the incurred claims, based on the paid and still outstanding claims (reserves) and/or based on the paid and incurred claims. The best neural network for each case may be determined e.g. by means of minimizing the absolute mean error of the predicted values and the actual values. For example, the ratio of the mean error to the mean predicted value (of the known claims) may be applied to the predicted values of the modeled values in order to obtain the error. For the case where the predicted values of the previous initial years is <sic. are> co-used for calculation of the following initial years, the error must of course be correspondingly cumulated. This can be achieved e.g. in that the square root of the sum of the squares of the individual errors of each model is used.

To obtain a further estimate of the quality and/or training state of the neural networks, e.g. the predicted values can also be fitted by means of the mentioned Pareto distribution. This estimation can also be used to determine e.g. the best neural network from among neural networks (e.g. paid claims, outstanding claims, etc.) trained with different sets of data (as described in the last paragraph). It thereby follows with the Pareto distribution

$${χ}^{2} = \sum {( \frac{O ( i ) - T ( i )}{E ( i )} )}^{2}$$

$$with$$

$$T ( i ) = Th ( {( 1 - P ( i ) )}^{( - 1 / α )} )$$

whereby α of the fit parameters, Th of the threshold parameters (threshold value), T(i) of the theoretical value of the i-th payment demand, O(i) of the observed value of the i-th payment demand, E(i) is the error of the i-th payment demand and P(i) is the cumulated probability of the i-th payment demand with

$$P ( 1 ) = ( \frac{1}{2 n} )$$

$$and$$

$$P ( i + 1 ) = P ( i ) + \frac{1}{n}$$

and n the number of payment demands. For the embodiment example here, the error of the systems based on the proposed neural networks was compared with the chain ladder method with reference to vehicle insurance data. The networks were compared once with the paid claims and once with the incurred claims. In order to compare the data, the individual values were cumulated in the development years. The direct comparison showed the following results for the selected example data per 1000

| | System Based on Neural Networks | | Chain Ladder Method | |
|---|---|---|---|---|
| Initial | Paid Claims | Incurred Claims | Paid Claims | Incurred Claims |
| Year | (cumulated values) | (cumulated values) | (cumulated values) | (cumulated values) |
| 1996 | 369.795 ± 5.333 | 371.551 ± 6.929 | 387.796 ± n/a | 389.512 ± n/a |
| 1997 | 769.711 ± 6.562 | 789.997 ± 8.430 | 812.304 ± 0.313 | 853.017 ± 15.704 |
| 1998 | 953.353 ± 40.505 | 953.353 ± 30.977 | 1099.710 ± 6.522 | 1042.908 ± 32.551 |
| 1999 | 1142.874 ± 84.947 | 1440.038 ± 47.390 | 1052.683 ± 138.221 | 1385.249 ± 74.813 |
| 2000 | 864.628 ± 99.970 | 1390.540 ± 73.507 | 1129.850 ± 261.254 | 1285.956 ± 112.668 |
| 2001 | 213.330 ± 72.382 | 288.890 ± 80.617 | 600.419 ± 407.718 | 1148.555 ± 439.112 |

The error shown here corresponds to the standard deviation, i.e. the σ₁-error, for the indicated values. In particular for later initial years, i.e. initial years with greater i, the system based on neural networks shows a clear advantage in the determination of values compared to the prior art methods in that the errors remain substantially stable. This is not the case in the state of the art since the error there does not increase proportionally for increasing i. For greater initial years i, a clear deviation in the amount of the cumulated values is demonstrated between the chain ladder values and those which were obtained with the method according to the invention. This deviation is based on the fact that in the chain ladder method the IBNYR (Incurred But Not Yet Reported) losses have been additionally taken into account. The IBNYR damage events would have to be added to the above-shown values of the method according to the invention. For example, for calculation of the portfolio reserves, the IBNYR damage events can be taken into account by means of a separate development (e.g. chain ladder). In reserving for individual losses or in determining loss amount distributions, the IBNYR damage events play no role, however.

### LIST OF REFERENCE SYMBOLS

T training phase

L determination phase after learning

Aᵢⱼ known event values

Bᵢⱼ event values generated by means of the system

1.-23. (canceled)

24. Computer-based system for automated experience rating and/or loss reserving, a certain event P_{if} of an initial time interval i including development values P_{ikf} of the development intervals k=1, . . . ,K, K being the last known development interval with i=1, . . . , K, and all development values P_{1kf} being known, characterized
in that the system for automated determination of the development values P_{i,K+2-i,f}, . . . ,P_{i,K,f} comprises at least one neural network, the system for determination of the development values P_{i,K+2-i,f}, . . . ,P_{i,K,f} of an event P_{i,f}(i−1) comprising iteratively generated neural networks Nᵢⱼ for each initial time interval i with j=1, . . . ,(i−1), and the neural network Nᵢⱼ₊₁ depending recursively on the neural network Nᵢⱼ.

25. Computer-based system according to claim 24, characterized in that for the events the initial time interval corresponds to an initial year, and the development intervals correspond to development years.

26. Computer-based system according to claim 24, characterized in that training values for weighting a particular neural network Nᵢⱼ comprise the development values P_{p,q,f} with p=1, . . . ,(i−1) and q=1, . . . ,K−(i−j).

27. Computer-based system according to claim 24, characterized in that the neural networks Nᵢⱼ for the same j are identical, the neural network N_{i+1,j=i} being generated for an initial time interval i+1, and all other neural networks N_{i+1,j<i} corresponding to networks of earlier initial time intervals.

28. Computer-based system according to claim 24, characterized in that the system further comprises events P_{i,f} with initial time interval i<1, all development values P_{i<1,k,f} being known for the events P_{i<1,f}.

29. Computer-based system according to claim 24, characterized in that the system comprises at least one scaling factor by means of which the development values P_{ikf} of the different events P_{i,f} are scalable according to their initial time interval.

30. Computer-based method for automated experience rating and/or loss reserving, development values P_{ikf} with development intervals k=1, . . . , K being assigned to a certain event P_{if} of an initial time interval i, K being the last known development interval with i=1, . . . , K, and all development values P_{1kf} being known for the events P_{1,f}, characterized
in that at least one neural network is used for determination of the development values P_{i,K+2-i,f}, . . . ,P_{i,K,f}, neural networks Nᵢⱼ being generated iteratively (i−1) for each initial time interval i with j=1, . . . ,(i−1), for determination of the development values P_{i,K-(i-j)+1,f}, and the neural network N_{i,j+1} depending recursively on the neural network Nᵢⱼ.

31. Computer-based method according to claim 30, characterized in that for the events the initial time interval is assigned to the initial year, and the development intervals are assigned to development years.

32. Computer-based method according to claim 30, characterized in that for weighting a particular neural network Ni,j, the development values P_{p,q,f} with p=1, . . . , (i−1) and q=1, . . . , K−(i−j) are used.

33. Computer-based method according to claim 30, characterized in that the neural networks Nᵢⱼ for same j are trained identically, the neural network N_{i+1,j=i} being generated for an initial time interval i+1, and all other neural networks N_{i+1,j<i} of earlier initial time intervals being taken over.

34. Computer-based method according to claim 30, characterized in that used in addition for determination are events P_{i,f} with initial time interval i<1, all development values P_{i<1,k,f} being known for the events P_{i<1,f}.

35. Computer-based method according to claim 30, characterized in that by means of at least one scaling factor the development values P_{ikf} of the different events P_{i,f} are scaled according to their initial time interval.

36. Computer-based method for automated experience rating and/or loss reserving, development values P_{i,k,f} with development intervals k=1, . . . , K being stored assigned to a certain event P_{i,f} of an initial time interval i, whereby i=1, . . . , K and K is the last known development interval, and whereby all development values P_{1,k,f} are known for the first initial time interval, characterized
in that, in a first step, for each initial time interval i=2, . . . ,K, by means of iterations j=1, . . . ,(i−1), at each iteration j, a neural network Nᵢⱼ is generated with an input layer with K−(i−j) input segments and an output layer, each input segment comprising at least one input neuron and being assigned to a development value P_{i,k,f},
in that, in a second step, the neural network Nᵢⱼ is weighted with the available events P_{i,f} of all initial time intervals m=1, . . . ,(i−1) by means of the development values P_{m, . . . K-(i-j),f} as input and P_{m,1 . . . K-(i-j)+1,f} as output, and
in that, in a third step, by means of the neural network Nᵢⱼ the output values O_{i,f} for all events P_{i,f} of the initial year i are determined, the output value O_{i,f} being assigned to the development value P_{i,K-(i-j)+1,f} of the event P_{i,f}, and the neural network Nᵢⱼ depending recursively on the neural network Nᵢⱼ₊₁.

37. Computer-based method according to claim 36, characterized in that for the events the initial time interval is assigned to an initial year, and the development intervals are assigned to development years.

38. System of neural networks, which neural networks Nᵢ each comprise an input layer with at least one input segment and an output layer, the input layer and output layer comprising a multiplicity of neurons which are connected to one another in a weighted way, characterized
in that the neural networks Nᵢ are able to be generated iteratively using software and/or hardware by means of a data processing unit, a neural network Nᵢ₊₁depending recursively on the neural network Nᵢ, and each network Nᵢ₊₁comprising in each case one input segment more than the network Nᵢ,
in that, beginning at the neural network Nᵢ, each neural network Nᵢ is trainable by means of a minimization module by minimizing a locally propagated error, and
in that the recursive system of neural networks is trainable by means of a minimization module by minimizing a globally propagated error based on the local error of the neural network Nᵢ.

39. System of neural networks according to claim 38, characterized in that the output layer of the neural network Nᵢ is connected to at least one input segment of the input layer of the neural network Nᵢ₊₁ in an assigned way.

40. Computer program product which comprises a computer-readable medium with computer program code means contained therein for control of one or more processors of a computer-based system for automated experience rating and/or loss reserving, development values P_{i,k,f} with development intervals k=1, . . . , K being stored assigned to a certain event P_{i,f} of an initial time interval i, whereby i=1, . . . , K, and K is the last known development interval, and all development values P_{1,k,f} being known for the first initial time interval i=1, characterized
in that by means of the computer program product at least one neural network is able to be generated using software and is usable for determination of the development values P_{i,K+2-i,f}, . . . , P_{i,K,f}, whereby, for
determination of the development values P_{i,K-(i-j)+1,f} neural networks Nᵢⱼ are able to be generated for each initial time interval i by means of the computer program iteratively (i−1) with j=1, . . . ,(i−1), and whereby the neural network N_{i, ,j+1} depends recursively on the neural network Nᵢⱼ.

41. Computer program product according to claim 40, characterized in that for the events the initial time interval is assigned to an initial year, and the development intervals are assigned to development years.

42. Computer program product according to claim 40, characterized in that for weighting a particular neural network Nᵢⱼ by means of the computer program product the development values P_{p,q,f} with p=1, . . . ,(i−1) and q=1, . . . ,K−(i−j) are readable from a database.

43. Computer program product according to claim 40, characterized in that with the computer program product the neural networks Nᵢⱼ are trained identically for the same j, the neural network N_{i+1 J=i} being generated for an initial time interval i+1 by means of the computer program product, and all other neural networks N_{i+1,j<i} of earlier initial intervals being taken over.

44. Computer program product according to claim 40, characterized in that the database additionally comprises in a stored way events P_{i,f} with initial time interval i<1, all development values P_{i<1,k,f} being known for the events P_{i<1,f}.

45. Computer program product according to claim 40, characterized in that the computer program product comprises at least one scaling factor by means of which the development values P_{ikf} of the different events P_{i,f} are scalable according to their initial time interval.

46. Computer program product which is loadable in the internal memory of a digital computer and comprises software code segments with which the steps according to claim 30 are able to be carried out when the product is running on a computer, the neural networks being able to be generated through software and/or hardware.
